(19) United States
(12) Patent Application Publication
(10) Pub. No.: US 2020/0398594 A1
(43) Pub. Date: Dec. 24, 2020

(54) POSITIONING REGISTRATION SURFACES

(71) Applicant: HEWLETT-PACKARD DEVELOPMENT COMPANY, L.P., Spring, TX (US)

(72) Inventors: Matthew REIER, Vancouver, WA (US); Luke P SOSNOWSKI, Vancouver, WA (US); Elliott DOWNING, Vancouver, WA (US); Robert YRACEBURU, Vancouver, WA (US); Arturo AYAIA, Vancouver, WA (US); Robert Scott BEALE, Vancouver, WA (US); Bruce G JOHNSON, Vancouver, WA (US)

(73) Assignee: Hewlett-Packard Development Company, L.P., Spring, TX (US)

(21) Appl. No.: 16/643,314

(22) PCT Filed: Sep. 12, 2017
(86) PCT No.: PCT/US2017/051140

§ 371 Date: Feb. 28, 2020

(51) Int. Cl. B41J 13/26; B41J 13/10; B65H 29/04

(52) U.S. Cl. CPC B41J 13/26; B41J 13/106; B65H 2801/27; B65H 2301/4212; B65H 29/041

(57) ABSTRACT

In one example, a system can include a media pathway to transport a media into a stacking region, a clamp pathway to move a clamp along the clamp pathway, and a registration surface. The registration surface may be positioned between an edge of the media pathway and the clamp pathway.

### BACKGROUND

Imaging systems, such as printers, generally include a stacking region for the collection of print media. The stacking region may be an output region where a user may receive the print medium. Imaging systems may be provided with a finishing mechanism where the print medium may be collected for post processing, such as stapling, three-hole punching, etc. The stacking region may be within the imaging system where the print medium are collected for post processing.

### BRIEF DESCRIPTION OF THE DRAWINGS

FIG. 1 illustrates an example of a system including a registration surface positioned consistent with the disclosure.

FIG. 2 illustrates an example of a finisher device including registration surfaces positioned consistent with the disclosure.

FIG. 3 illustrates an example of a finisher device including registration surfaces positioned consistent with the disclosure.

FIG. 4 illustrates an example of a printing device including registration surfaces positioned consistent with the disclosure.

FIG. 5 illustrates a view of a portion of a finisher device including registration surfaces positioned consistent with the disclosure.

FIG. 6 illustrates another view of a portion of a finisher device including registration surfaces positioned consistent with the disclosure.

### DETAILED DESCRIPTION

Various examples provide for positioning registration surfaces. A print device (e.g., specifically a finisher device) may include a clamping mechanism to deliver a print media (e.g., sheet) onto a stacking region which may collect a stack of sheets. Examples of the disclosure may simplify positioning registration surfaces while reducing and/or eliminating a chance of media being buckled and/or excessively rotate around on at least one of the registration surfaces.

As described herein, in some examples, print media may be collected for a finishing process (e.g., stapling, three-hole punching, etc.). In some cases, such as in inkjet printers where the printing fluid may not be fully dried during stacking, alignment of print media in a stack may become difficult. For example, the print media can be partially dried inkjet media when the printing fluid is deposited on the print media at a print zone of the inkjet printer. In some examples, the partially dried inkjet media may be distorted from curl forming on the edges. Due to the moisture content, the partially dried inkjet media may have reduced stiffness which leads to buckling, and high print fluid density regions may result in increased friction with adjacent sheets of partially dried inkjet media. The friction can result in misalignment with other sheets of partially dried inkjet media in the stack. Additionally, curling of the sheets of partially dried inkjet media can result in trapped air between the sheets. The trapped air can result in a variety of issues, such as an artificial increase in stack height of sheets of print media.

Various print devices may utilize clamping systems to deliver a print media to a stacking region. For example, the clamping system may include a clamp that clamps a leading edge of the print media up to a point where a registration surface is located. When the leading edge of the print media contacts the registration surface, the print media may be released from the clamp, and delivered to a stacking region. In some examples, the print device may include two individual registration surfaces positioned between guiding rails (and/or clamps) along which a corresponding clamp may move. However, the two registration surfaces positioned as such may result in imbalanced forces exerted from the two registration surfaces to the print media. The imbalanced forces can cause buckling (between the clamp and the registration surface) and/or an excessive rotation of the print media. As such, having the two registration surfaces may utilize further testing and/or calculation to balance the forces (e.g., by determining where to position the two registration surfaces), which may be costly and time-consuming, particularly, at a manufacturing level. Further, the two registration surfaces adjusted to balance the forces may still result in a buckling and/or an excessive rotation.

Accordingly, the disclosure is directed to a registration surface positioned between an edge of a media pathway and a clamp pathway. For example, when a clamping system includes two individual clamps, two rails may be positioned between the two individual registration surfaces in contrast to some previous approaches, in which two individual registration surfaces were positioned between two rails. In some examples, a registration surface positioned according to the disclosure may decrease a potential for buckling and rotation, and/or simplify positioning registration surfaces to reduce manufacturing cost.

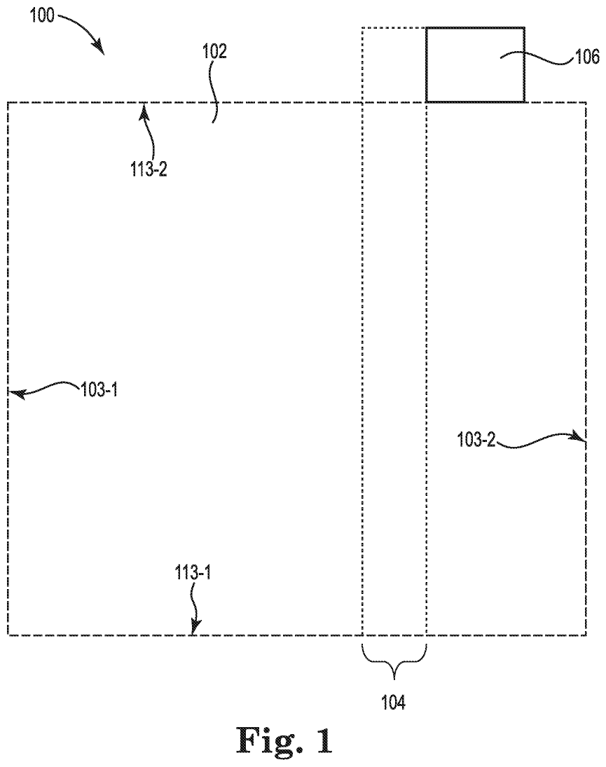

FIG. 1 illustrates an example of a system 100 including a registration surface 106 positioned consistent with the disclosure. The system may include a media pathway 102, a clamp pathway 104, and a registration surface 106, as shown in FIG. 1. The system 100 can be part of a finisher device of a printing device. For example, the system 100 can be part of a finisher device of an inkjet printing device as described herein. As used herein, a clamp pathway 104 may refer to a pathway along which a clamp may move. As used herein, a media pathway 102 may refer to a pathway along which a media may be transported. An edge of the media pathway may refer to a pathway along the sides of the media (e.g., that are perpendicular to a leading edge of the media) travel when being transported by a clamp.

In various examples, the media pathway 102 may be a pathway along which a media may be transported, for example, by a clamp. For example, a leading edge of a media may be clamped at a first end 113-1 of the media pathway 102, and may be transported along the media pathway 102 such that the leading edge of the media arrives at a second end 113-2 of the media pathway 102. At the second end of the media pathway 102, the media may contact the registration surface 106, and may be released such that the media may be delivered into a stacking region, which may be located below the media pathway. As shown in FIG. 1, the media pathway 102 may include an edge and an end such as a first end 113-1, a second end 113-2, a first edge 103-1, and a second edge 103-2. In some examples, the media transported to the second end of the media pathway 102 may be superimposable to the media pathway 102.

In various examples, the clamp pathway 104 may be a pathway along which a clamp may move. For example, a clamp may clamp a media at one end of the clamp pathway 104 (e.g., the first end 113-1 of the media pathway 102) and move along the clamp pathway 104 (e.g., upward). As is shown in FIG. 1, the clamp pathway 104 extends from a first end 113-1 of the media pathway 102 and beyond the second end 113-2 of the media pathway 102, as illustrated in FIG. 1. That is, a clamp may travel (e.g., move) beyond a point where a leading edge of the media contacts the registration surface 106. When the media is released at the registration surface 106, the clamp may move back to where a leading edge of another media is positioned (e.g., a bottom end of the clamp pathway 104 that may be analogous to the first end 113-1 of the media pathway 102), as described herein.

In some examples, the clamp pathway 104 may be defined by a rail such that the clamp may move along the rail extending through the clamp pathway 104. In some examples, the clamp pathway 104 may be parallel (e.g., substantially parallel) to the media pathway 102.

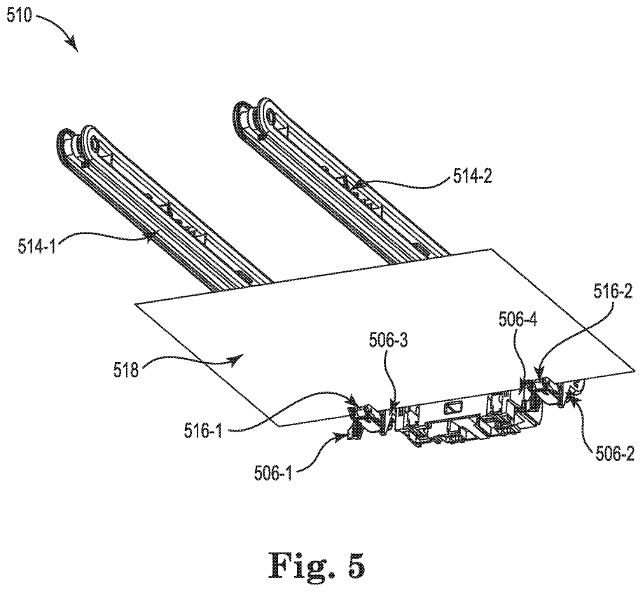

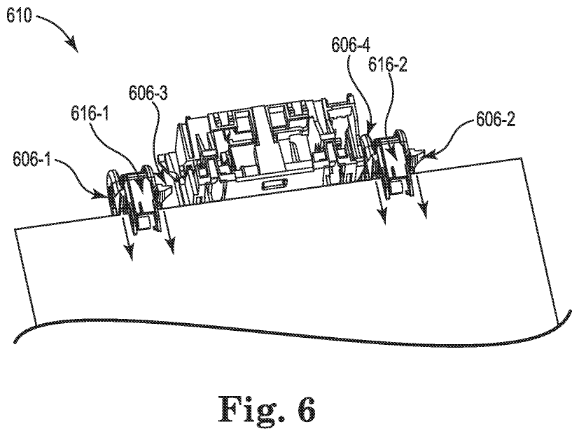

In various examples, the registration surface 106 may be positioned between an edge 103-2 of the media pathway 102 and the clamp pathway 104. In some examples, the registration surface 106 may extend vertically out of a plane where media pathway 102 lies, as described herein. The registration surface 106 are further described in FIG. 5 and FIG. 6.

In some examples, the registration surface 106 may be positioned at a second end 113-2 of the media pathway 102, as illustrated in FIG. 1. As such, a leading edge of the media may contact the registration surface 106 to be released from, for example, a clamp at the second end 113-2 of the media pathway 102.

In some examples, the registration surface 106 may be coupled to the clamp pathway 104, as illustrated in FIG. 1, That is, in an example where a rail defines the clamp pathway 104 and extends along the clamp pathway 104, the registration surface 106 may be coupled to the rail. Positioning the registration surface 106 next to (e.g., coupled to) the clamp pathway 104 (e.g., rail) may provide less space to buckle (e.g., a media being buckled between the clamp and the registration surface 106) before being released from the clamp.

In some examples, the clamp pathway 104 may be located between a centerline of the media pathway 102 and the edge 103-2 of the media pathway 102. That is, the clamp pathway 104 may be positioned between the centerline of the media pathway 102 and the registration surface 106. In some examples, the clamp pathway 104 could exist along the centerline of 102.

In some examples, the system 100 may include more than one clamp pathway 104 and the registration surface 106. That is, the system 100 may include more than one clamp (and/or a rail) and one registration surface 106. A system and/or a device including a plurality of clamp pathways and registration surfaces are described further herein.

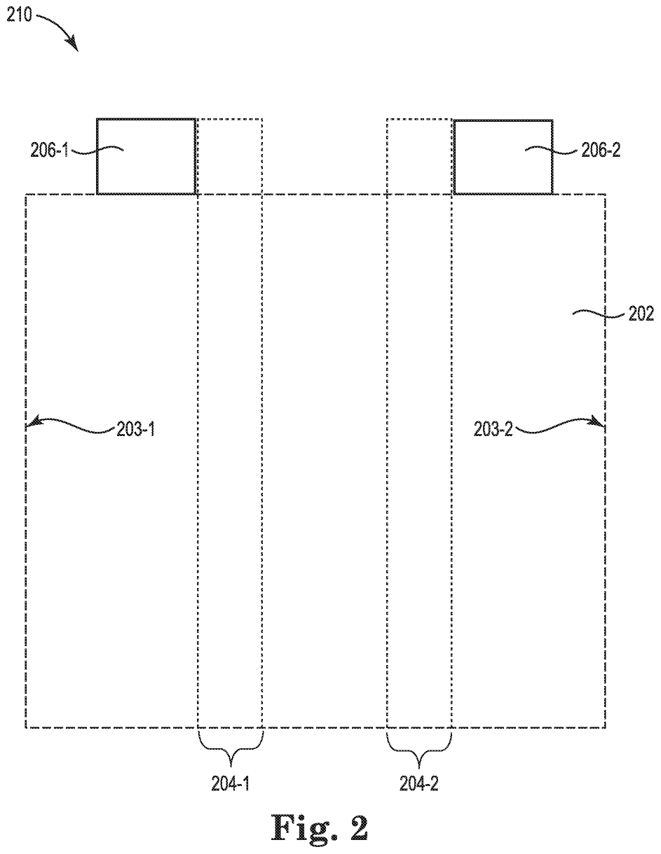

FIG. 2 illustrates an example of a finisher device 210 including registration surfaces 206-1 and 206-2 positioned consistent with the disclosure. As shown in FIG. 2, the finisher device 210 may include a media pathway 202, a first clamp pathway 204-1, a second clamp pathway 204-2 (e.g., collectively referred to as clamp pathways 204), a first registration surface 206-1, and a second registration surface 206-2 (e.g., collectively referred to as “registration surfaces 206).

The media pathway 202 may include a first edge 203-1 and a second edge 203-2, as shown in FIG. 2. In some examples, the finisher device 210 can be utilized to stack partially dried inkjet media. For example, the finisher device 210 can be part of an inkjet printing device that can be utilized to stack and perform a finishing process (e.g., stapling, collating, hole punching, etc.). In some examples, the registration surfaces 206 may extend vertically out of a plane where media pathway 202 lies, as described herein. The registration surface 206 are further described in FIG. 5 and FIG. 6.

In various examples, the first registration surface 206-1 may be positioned between the first clamp pathway 204-1 and the first edge 203-1 of the media pathway 202, and the second registration surface 206-2 may be positioned between the second clamp pathway 204-2 and the second edge 203-2 of the media pathway 202. That is, the clamp pathways 204 may be located between the first registration surface 206-1 and the second registration surface 206-2.

In some examples, one of the registration surfaces 206 may serve as a point of rotation, and another one of the registration surfaces 206 may serve as a rotation stop. For example, media that is transported to an end of the media pathway 202 (where the first registration surface 206-1 and the second registration surface 206-2 are aligned) may contact one of the registration surfaces, for example, the first registration surface 206-1. Then, the media may rotate around the first registration surface 206-1 (e.g., along an axis extending vertically out of a plane where the media pathway 202 lies) until the media contacts the second registration surface 206-2. When the media contacts the second registration surface 206-2, the media may be fully registered (aligned) at the registration surfaces 206. At this point, the media may be released from clamps due to the registration surfaces 206 prohibiting the media to be transported further beyond the end of the media pathway 202. Then, the media may be delivered to a stacking region, and the clamps may move back to where they clamped a leading edge of the media). In some approaches, registration surfaces positioned between two clamp pathways may often be imbalanced in terms of forces being exerted from the registration surfaces to the media, which may result in an excessive rotation of the media. This imbalance of force can occur particularly when the second registration surface (serving as a rotation stop) does not provide enough force as compared to the first registration surface (serving as a point of rotation). As such, registration surfaces positioned according to the disclosure with balanced forces provides benefits such as reducing and/or eliminating an excessive rotation of the media.

In some examples, the first clamp pathway 204-1 and the second clamp pathway 204-2 may be symmetrical to one another with respect to a centerline of the media pathway 202, as described further herein. Similarly, the first registration surface 206-1 and the second registration surface 206-2 may be positioned symmetrical to one another. Therefore, cost associated with manufacturing a finisher device may be reduced since positions of the first registration surface 206-1 and the second registration surface 206-2 need not be, at a manufacturing level, adjusted to reduce buckling and/or rotating, compared to some previous approaches.

In some examples, the finisher device 200 may further include a third registration surface and a fourth registration surface positioned, for example, between the first clamp pathway 204-1 and the second clamp pathway 204-2. For example, the third registration surface may be coupled to the first clamp pathway 204-1 (e.g., to which the first registration surface 206-1 may be coupled to) and the fourth registration surface may be coupled to the second clamp pathway 204-2 (e.g., to which the second registration surface 206-2 may be coupled to) such that two registration surfaces may be coupled to each of the clamp pathways 204.

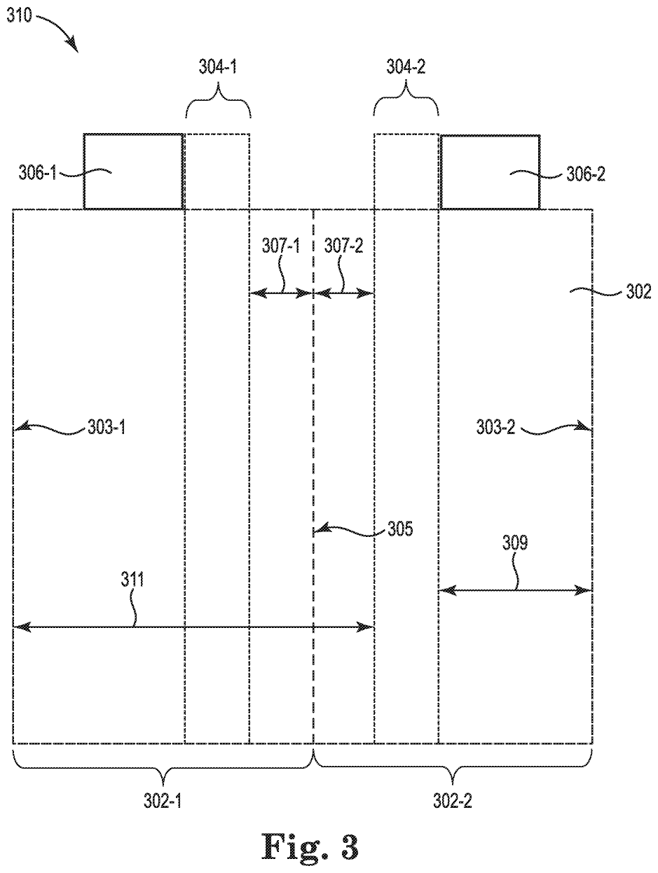

FIG. 3 illustrates an example of a finisher device 310 including registration surfaces 306-1 and 306-2 positioned consistent with the disclosure. As shown in FIG. 3, the finisher device 310 may include a media pathway 302, a first clamp pathway 304-1, a second clamp pathway 304-2 (e.g., collectively referred to as clamp pathways 304), a first registration surface 306-1, and a second registration surface 306-2 (e.g., collectively referred to as registration surfaces 306). In some examples, the registration surfaces 306 may extend vertically out of a plane where media pathway 302 lies, as described herein. The registration surfaces 306 are further described in FIG. 5 and FIG. 6.

The media pathway 302 may include a first edge 303-1 and a second edge 303-2, as shown in FIG. 3. In some examples, the finisher can be utilized to stack partially dried inkjet media. For example, the finisher device 310 can be part of an inkjet printing device that can be utilized to stack and perform a finishing process (e.g., stapling, collating, hole punching, etc.).

In various examples, the first registration surface 306-1 may be positioned between the first edge 303-1 and the first clamp pathway 304-1, and the second registration surface 306-2 may be positioned between the second edge 303-2 and the second clamp pathway 304-2. That is, the clamp pathways 304 may be located between the first registration surface 306-1 and the second registration surface 306-2.

In various examples, the first clamp pathway 304-1 and the first registration surface 306-1 may be included on a same side of the media pathway 302. For example, given that a first half 302-1 (e.g., left half as shown in FIG. 3) of the media pathway 302 can be separated from a second half 302-2 (e.g., right half as shown in FIG. 3) of the media pathway 302 along a centerline 305 of the media pathway 302, the first clamp pathway 304-1 and the first registration surface 306-1 may be included in the first half 302-1 of the media pathway 302. Similarly, the second clamp pathway 304-2 and the second registration surface 306-2 may be included on a same side of the media pathway 302, which may be the second half 302-2 of the media pathway 302.

In some examples, the second clamp pathway 304-2 may be located closer to the second edge 303-2 of the media pathway 302 than to the first edge 303-1 of the media pathway 302. For example, a distance 309 between the second clamp pathway 304-2 and the second edge 303-2 may be shorter than a distance 311 between the second clamp pathway 304-2 and the first edge 303-1. Similarly, the first clamp pathway 304-1 may be located closer to the first edge 303-1 of the media pathway 302 than to the second edge 303-2 of the media pathway 302. The distance 309 may be shorter than the distance 311 regardless of a width of the clamp pathway 302-2.

In some examples, the first clamp pathway 304-1 and the second clamp pathway 304-2 may be symmetrical to one another with respect to a centerline 305 of the media pathway 302. That is, a first distance 307-1 between the first clamp pathway 304-1 and the centerline 305 may be equal (e.g., substantially equal) to a second distance 307-2 between the second clamp pathway 304-2 and the centerline 305.

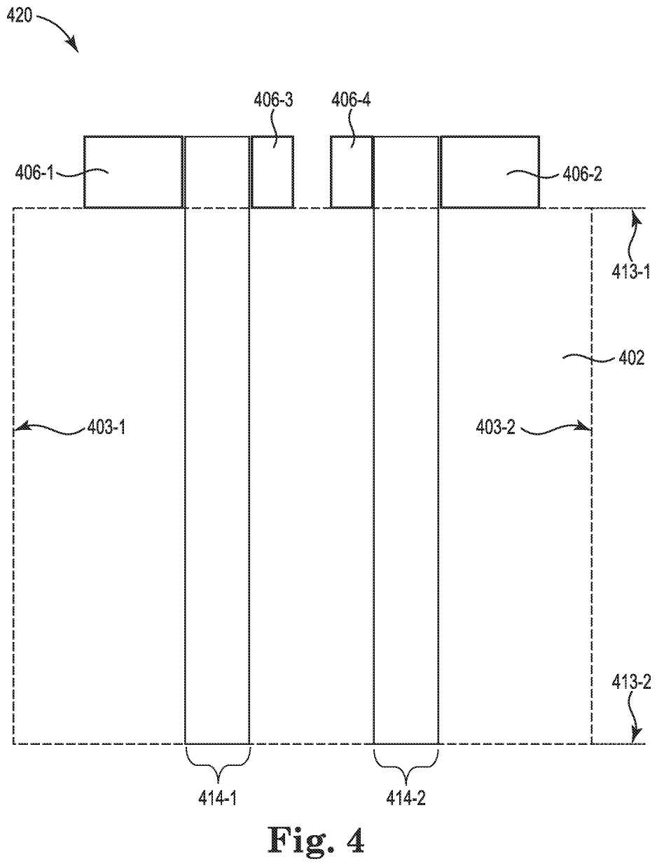

FIG. 4 illustrates an example of a printing device 420 including registration surfaces 406-1, . . . , 406-4 positioned consistent with the disclosure. Registration surfaces 406-1, . . . , 406-4 may be included in a finisher device of the printing device 420, as described herein.

As shown in FIG. 4, the printing device 420 may include a media pathway 402, a first rail 414-1, a second rail 414-2 (e.g., collectively referred to as rails 414), a first registration surface 406-1, a second registration surface 406-2, a third registration surface 406-3, and a fourth registration surface 406-4 (e.g., collectively referred to as registration surfaces 406). The media pathway 406 may include a first edge 403-1 and a second edge 403-2, as shown in FIG. 4. In some examples, the registration surfaces 406 may extend vertically out of a plane where media pathway 402 lies, as described herein. The registration surfaces 406 are further described in FIG. 5 and FIG. 6.

The rails 414 may be utilized to move a clamp from a first end of the rails 414 to a second end of the rails 414. The first end of the rails 414 may be aligned along the first end 413-1 of the media pathway 402, and the rails 414 may extend from the first end 413-1 of the media pathway 402 beyond the second end 413-2 of the media pathway 402. As such, the clamp moving along the rails 414 may move beyond the second end 413-2 of the media pathway 402 while the media being transported by the clamp may stop and be released at the second end 413-2 of the media pathway. In various examples, the rails 414 may be, for example, continuous.

In various examples, the rails 414 may each include a corresponding clamp. For example, the first rail 414-1 may include a first clamp and the second rail 414-2 may include a second clamp. The first clamp and the second clamp may move along a corresponding rail (e.g., the first rail 414-1 or the second rail 414-2), for example, from the first end 413-1 of the media pathway 402 to the end of the corresponding rail, which extends beyond the second end 413-2 of the media pathway 402. As such, the media may be clamped at the first end 413-1 of the media pathway 402, and transported by the clamps (the first clamp and the second clamp) until the media contacts at least one of the registration surfaces 406 at the second end 413-2 of the media pathway 402.

As shown in FIG. 4, the first registration surface 406-1 and the third registration surface 406-3 (e.g., a first set of registration surfaces) may be coupled to the first rail 414-1, and the second registration surface 406-2 and the fourth registration surface 416-4 (a second set of registration surfaces) may be coupled to the second rail 406-2. Additional registration surfaces in addition to the first registration surface 406-1 and the second registration surface 406-2 provides benefits such as reducing and/or eliminating unbalanced forces and/or reducing contact stresses that can result in a buckling of and/or a damage to a media. For example, a moment generated by the first registration surface 406-1 and the pull of clamps on the rails 414, which may cause unbalanced force against the second registration surface 406-2, may be offset by the third registration surface 406-3 coupled to the first rail 414-1. Similarly, a moment generated by the second registration surface 406-2 and the pull of the clamps on the rails 414 may be offset by the fourth registration surface 406-4 coupled to the second rail 414-2.

In some examples, the first set of registration surfaces (including the first registration surface 406-1 and the third registration surface 406-3) and the second set of registration surfaces (including the second registration surface 406-2 and the fourth registration surface 406-4) may be aligned along an end of the media pathway. For example, a leading edge of a media transported (e.g., by a clamp moving along the first rail 414-1 and/or the second rail 414-2) up to the end of the media pathway 402 may contact at least one of the registration surface 406 such that the media may be released at the end of the media pathway 402.

In some examples, the first set of registration surfaces (including the first registration surface 406-1 and the third registration surface 406-2) may be positioned closer to the first edge 403-1 of the media pathway 402 than to the second edge 403-2 of the media pathway 402, as described herein. Similarly, the second set of registration surface (including the second registration surface 406-2 and the fourth registration surface 406-4) may be positioned closer to the second edge 403-2 of the media pathway 402 than to the first edge 403-1 of the media pathway 402.

In various examples, at least one of the first set of registration surfaces (including the first registration surface 406-1 and the third registration surface 406-3) may be positioned between the first edge 403-1 of the media pathway 402 and the first rail 414-1. For example, the first registration surface 406-1 may be positioned between the first edge 403-1 and the first rail 414-1. Similarly, at least one of the second set of registration surfaces (including the second registration surface 406-2 and the fourth registration surface 406-4) between the second edge 403-1 of the media pathway 402 and the second rail 414-2. For example, the second registration surface 406-2 may be positioned between the second edge 403-2 and the second rail 414-2.

In some examples, at least one of the first set of registration surfaces may be positioned between the first rail 414-1 and the second rail 414-2. For example, the third registration surface 406-3 may be positioned between the first rail 414-1 and the second rail 414-2. Similarly, at least one of the second set of registration surfaces may be positioned between the first rail 414-1 and the second rail 414-2. For example, the fourth registration surface 406-4 may be positioned between the first rail 414-1 and the second rail 414-2.

FIG. 5 illustrates a view of a portion of a finisher device 510 including registration surfaces 506-1, . . . , 506-4 positioned consistent with the disclosure. The finisher device 510 may be the same or similar finisher device as finisher device 210 as referenced in FIG. 2, and/or finisher device 310 as referenced in FIG. 3. For example, the finisher device 510 may include a first registration surface 506-1, a second registration surface 506-2, a third registration surface 506-3, a fourth registration surface 506-4 (collectively referred to as registration surfaces 506), and a first rail 514-1, a second rail 514-2 (collectively referred to as rails 514).

In some examples, the finisher device 510 can be utilized to stack partially dried inkjet media. For example, the finisher device 510 can be part of an inkjet printing device that can be utilized to stack and perform a finishing process (e.g., stapling, collating, hole punching, etc.). As shown in FIG. 5, the finisher device 510 may include a media 518 that may be transported along a media pathway (not shown), and a first clamp 516-1 and a second clamp 516-2 that may move along the first rail 514-1 and the second rail 514-2, respectively.

The media 518 may be clamped by the first clamp 516-1 and/or the second clamp 516-2 at one end of the rails 514, and transported up to at least one of the registration surfaces 506. The first clamp 516-1 and the second clamp 516-2 may travel along a corresponding rail. For example, the first clamp 516-1 may travel along the first rail 514-1 and the second clamp 516-2 may travel along the second rail 514-2. The rails 514 may include a clamp pathway continuously extending on both sides of the rails 514. That is, the first clamp 516-1 and the second clamp 516-2 may travel on either side of a corresponding rail. For example; the first clamp 516-1, which moved on a first side (e.g., lower side) to a point where the media 518 contacts at least one of the registration surfaces 506, may rotatably move onto a second side (upper side) such that the first clamp 516-1 moves on the second side back to a point, where the first clamp clamped the media 518. Similarly, the second clamp 516-2 may move on both sides of the second rail 514-2.

As shown in FIG. 5, two registration surfaces may be coupled to each of the rails 514. For example, the first registration surface 506-1 and the third registration surface 506-3 may be coupled to the first rail 514-1, and the second registration surface 506-2 and the fourth registration surface 506-4 may be coupled to the second rail 514-2. Each registration surface coupled to a corresponding rail may be positioned on both sides of the corresponding rail. For example, the first registration surface 506-1 may be coupled to a left side of the first rail 514-1 while the third registration surface 506-3 may be coupled to a right side of the first rail 514-1, as shown in FIG. 5. Similarly, the second registration surface 506-2 may be coupled to a right side of the second rail 514-2 while the fourth registration surface 506-4 may be coupled to a left side of the second rail 514-2. As such, the first rail 514-1 and the second rail 514-2 are positioned between the first registration surface 506-1 and the second registration surface 506-2, and the third registration surface 506-3 and the fourth registration surface 506-4 are positioned between the first rail 514-1 and the second rail 514-2.

FIG. 6 illustrates another view of a portion of a finisher device 610 including registration surfaces 606-1, . . . , 606-4 positioned consistent with the disclosure. The finisher device 610 may be the same or similar finisher device as finisher device 210 as referenced in FIG. 2, finisher device 310 as referenced in FIG. 3, and/or finisher device 510 as referenced in FIG. 5.

In some examples, the finisher device 610 can be utilized to stack partially dried inkjet media. For example, the finisher device 610 can be part of an inkjet printing device that can be utilized to stack and perform a finishing process (e.g., stapling, collating, hole punching, etc.). As shown in FIG. 6, the finisher device 610 may include a media that may be transported along a media pathway (not shown), and a first clamp 616-1 and a second clamp 616-2 that may move along a corresponding rail (e.g., a first rail 514-1 and/or a second rail 514-2, as shown in FIG. 5), respectively.

As shown in FIG. 6, the registration surfaces 606-1, . . . , 606-4 may extend vertically (e.g., downward and/or upward) out of a plane where a media lies. In some examples, the registration surfaces 606-1, . . . , 606-4 may be coupled to a corresponding rail along which a clamp moves, although examples are not so limited.

As shown in FIG. 6, a first clamp 616-1 may move along a clamp pathway (not shown) that is located between a first registration surface 606-1 and a third registration surface 606-3. Similarly, a second clamp 616-2 may move along a clamp pathway (not shown) that is located between a second registration surface 606-2 and a fourth registration surface 606-4, In various examples, registration surfaces 606-1, . . . , 606-4 may be positioned on (e.g., coupled to) a corresponding clamp pathway. As such, the first registration surface 606-1 and the third registration surface 606-3 may be positioned closely to the first clamp 616-1, for example, when the first clamp 616-1 transports a media to a point where the media contacts the registration surfaces. Similarly, the second registration surface 606-2 and the fourth registration surface 606-4 may be positioned closely to the second clamp 616-2, for example, when the second clamp 616-2 transports a media to a point where the media contacts the registration surfaces. Positioning a registration surface closely to a clamp provide benefits such as providing less space between the registration surface and the clamp, in which a media often buckles.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A system, comprising:
a media pathway to transport a media into a stacking region;
a clamp pathway to move a clamp along the clamp pathway; and
a registration surface positioned between an edge of the media pathway and the clamp pathway.

2. The system of claim 1, wherein the clamp pathway is located between a centerline of the media pathway and the edge of the media pathway.

3. The system of claim 1, wherein the clamp pathway is parallel to the media pathway.

4. The system of claim 1, wherein the registration surface is coupled to the clamp pathway.

5. The system of claim 1, wherein a leading edge of the media is transported from a first end of the media path to the second end of the media path, and wherein the registration surface is positioned at the second end of the media pathway.

6. A finisher device, comprising:
a first clamp pathway and a second clamp pathway to move a clamp along the first clamp pathway and the second clamp pathway;
a first registration surface positioned between the first clamp pathway and a first edge of a media pathway; and
a second registration surface positioned between the second clamp pathway and a second edge of the media pathway.

7. The finisher device of claim 6, wherein a first half of the media pathway is separated from a second half of the media pathway along a centerline of the media pathway, and wherein the first clamp pathway and the first registration surface are included in the first half of the media pathway.

8. The finisher device of claim 6, wherein the second clamp pathway is located closer to the second edge of the media pathway than to the first edge of the media pathway.

9. The finisher device of claim 6, wherein the first clamp pathway and the second clamp pathway are symmetrical to one another with respect to a centerline of the media pathway.

10. The finisher device of claim 6, comprising a third registration surface and a fourth registration surface positioned between the first clamp pathway and the second clamp pathway.

11. A printing device, comprising:
a media pathway to transport a media from a first end of the media pathway to a second end of the media pathway;
a first rail and a second rail to move a clamp along the first rail and the second rail;
a first set of registration surfaces positioned on the first rail, at least one of the first set of registration surfaces positioned between a first edge of the media pathway and the first rail; and
a second set of registration surfaces positioned on the second rail, at least one of the second set of registration surfaces positioned between a second edge of the media pathway and the second rail.

12. The printing device of claim 11, wherein the first set of registration surfaces are positioned closer to the first edge of the media pathway than to the second edge of the media pathway.

13. The printing device of claim 11, wherein the first set of registration surfaces are coupled to the first rail and the second set of registration surfaces are coupled to the second rail.

14. The printing device of claim 11, wherein the first set of registration surfaces and the second set of registration surfaces are aligned along an end of the media pathway.

15. The printing device of claim 11, wherein:
at least one of the first set of registration surfaces is positioned between the first ail and the second rail; and
at least one of the second set of registration surfaces is positioned between the first rail and the second rail.
